(19) United States
(12) Patent Application Publication
(10) Pub. No.: US 2026/0216546 A1
(43) Pub. Date: Jul. 30, 2026

(54) Water Extinguishing System and Method of Performing a Pump Operation Therein

(71) Applicant: Minimax Viking Patent Management GmbH, Bad Oldesloe (DE)

(72) Inventors: Joachim BÖKE; Stephan BLUDAU; Frank FRIEDE; Dirk HOCHHAUS; Ruben STRAHLENDORF

(21) Appl. No.: 19/143,043

(22) PCT Filed: Dec. 21, 2023
(86) PCT No.: PCT/EP2023/087314

§ 371 Date: Jun. 25, 2025

(30) Foreign Application Priority Data
Dec. 27, 2022 (EP) 22216728.0

(51) Int. Cl. A62C 37/50

(52) U.S. Cl. CPC A62C 37/50

(57) ABSTRACT

The invention relates to a water extinguishing system (1) comprising a fluid supply line (20) for providing an extinguishing fluid, a fluid distribution line (30) for distributing the extinguishing fluid to at least one extinguishing fluid outlet (61), a pump (10) comprising a housing, a pump inlet in fluid connection with the fluid supply line (20) and a pump outlet in fluid connection with the fluid distribution line (30) and a control unit (50), wherein the water extinguishing system (1) comprises a plurality of sensors (21, 22, 23, 24, 25, 26, 27) in signal connection with the control unit (50), wherein each of the plurality of sensors (21, 22, 23, 24, 25, 26, 27) is configured to obtain at least one parameter value of a parameter indicative of an operating state of the water extinguishing system (1), wherein control unit (50) is configured to receive the at least one parameter value from at least one of the plurality of sensors (21, 22, 23, 24, 25, 26, 27), determine, based on an evaluation of the at least one parameter value, at least one pump operation condition and control a pump operation comprising a pump test run based on the at least one pump operation condition.

The present invention relates to a water extinguishing system and a method for controlling a pump operation, in particular a pump test run, in such a water extinguishing system.

Water extinguishing systems according to the invention are in particular sprinkler, water spray and foam extinguishing systems, wherein the invention is not limited to special types of water extinguishing systems but may encompass others. The concept commonly connecting water extinguishing systems is that these systems encompass an extinguishing fluid, typically comprising or consisting of water, being pumped from a fluid supply line for providing the extinguishing fluid to a fluid distribution line that distributes the extinguishing fluid throughout a pipe network of the water extinguishing system to one or more-typically a plurality of—fluid outlets, such as sprinklers or fluid nozzles.

The present invention relates in particular to water extinguishing systems comprising a fluid supply line for providing an extinguishing fluid, a fluid distribution line for distributing the extinguishing fluid to at least one extinguishing fluid outlet, a pump comprising a housing, a pump inlet in fluid connection with the fluid supply line and a pump outlet in fluid connection with the fluid distribution line and a control unit.

In some embodiments, the at least one extinguishing fluid outlet is part of a pipe system of the water extinguishing system, the pipe system being distributed throughout a room or place in which the water extinguishing system is provided for the purpose of fire protection.

In some embodiments, the water extinguishing system may further comprise a test line which branches off from the fluid distribution line and is configured to conduct the extinguishing fluid pumped by the pump away from the pipe system, preferably into a fluid storage for (re-) storing the extinguishing fluid conducted through the test line or a discharge element for discharging the extinguishing fluid. The test line may have an opening element which is designed to be movable between a locking position in which the opening element closes the test line and an unlocking position in which the opening element opens the test line. In some embodiments, the water extinguishing system may further comprise a fluid bypass line which may have a reduced cross-section in comparison with the test line. The fluid bypass line may be configured to conduct a predefined portion of the extinguishing fluid around the opening element of the test line away from the pipe system.

In some embodiments, the water extinguishing system may further comprise at least one valve element provided within the fluid distribution line comprising a valve inlet in fluid connection with the pump outlet and a valve outlet in fluid connection with the at least one extinguishing fluid outlet, the valve element configured to control a flow of the extinguishing fluid between the valve inlet and the valve outlet based on an alarm state of the water extinguishing system. Hereby, the valve element may preferably be an alarm valve as known in the art and the alarm state may particularly refer to a state in which an alarm is indicated as a first state and a state in which no alarm is indicated as a second state.

In this context, a fluid supply line may particularly refer to an element which serves to supply the extinguishing fluid towards the pump of the water extinguishing system. In some embodiments, a fluid supply line may particularly correspond to a pipe. The fluid supply line, in particular the pipe, may, at its one end, be fluidly connected to the pump and, at its other end, be fluidly connected to a fluid storage, such as a reservoir, in which the extinguishing fluid can be stored, or a fluid supply element, such as a drinking water supply from which drinking water can be supplied to the water extinguishing system as extinguishing fluid through the supply line.

A fluid distribution line, in this context, may refer to an element which serves to distribute the extinguishing fluid from the pump into the water extinguishing system towards the fluid outlets. In some embodiments where the water extinguishing system comprises a pipe network with one or more fluid outlets, the fluid distribution line may particularly correspond to a line which serves to distribute the extinguishing fluid pumped by the pump throughout the pipe network. In some embodiments, the fluid distribution line may particularly be embodied as a pipe. The fluid distribution line may, at its first end, be fluidly connected to the pump, and, at its second end, be fluidly connected to at least one fluid outlet. In some embodiments, the fluid distribution line may, at its second end, be fluidly connected to a pipe network comprising at least one fluid outlet. In some embodiments, the fluid distribution line describes in particular a pipe that either directly feeds a branch pipe or a single sprinkler or nozzle on a branch pipe that is not a tailpipe and is longer than 300 mm.

A pump that may be provided in the water extinguishing system may particularly be a motor-driven pump, typically an electrical pump or a diesel pump, configured to pump the extinguishing fluid from the supply line towards the distribution line for distribution to the fluid outlets. For this purpose, the pump may particularly separate the fluid supply line and the fluid distribution line. It is noted that the pump needs not necessarily be part of either one, but may also be situated away from the fluid supply line and the fluid distribution line, as long as it allows to pump the fluid from the fluid supply line to the fluid distribution line. The pump may hereby be, at its one end, in fluid connection with the fluid supply line and, at its other end, be in fluid connection with the fluid distribution line. In some embodiments, where the fluid supply line and the fluid distribution line correspond to pipes, this means that the pump is provided in between these pipes and used for pumping the fluid from one (supply) pipe to the other (distribution) pipe.

The term extinguishing fluid may particularly refer to a fluid which is used to extinguish and/or fight fires. This extinguishing fluid may in particular be extinguishing water provided with or without additives. In some embodiments the extinguishing fluid may contain in particular a foam, an anti-freezing agent or similar. If possible, the additives should be selected so as to be optimal for the respective application of the water extinguishing system. In some embodiments the extinguishing fluid may also be pure extinguishing water. Other extinguishing fluids are also conceivable.

A test line may particularly refer to a water measuring device comprising a flow meter, calming sections and regulating valves for testing the water rate. The test line is preferably provided as a branch line from the fluid supply line or the fluid distribution line of the water extinguishing system, even more particularly as a branch line from the fluid distribution line, which is positioned behind the pump in flow direction. The test line may further comprise an opening element. In this context, an opening element is understood in particular to be a sliding element within an opening unit, such as a valve, which can be operated manually in accordance with the prior art. Opening is effected by moving the sliding element from a locking to an unlocking position. Opening the opening element in the test line enables a volume flow through the test line, by means of which a pump test run can be carried out.

Closing is then effected by moving the sliding element from the unlocking position to the locking position. This interrupts the volume flow through the test line again.

A fluid bypass line may particularly refer to an additional fluid-conducting line, which is provided in addition to the test line and may either also branch off from the fluid supply line, the fluid distribution line or from the test line. The fluid bypass line may typically have a cross-section that is much smaller than that of the test line. In some embodiments, for example, the cross-section of the fluid bypass line corresponds to only 2 to 10% of the cross-section of the test line, in other embodiments even less. Usually, the cross-section of the fluid bypass line is selected to conduct in particular 2% of the flow of the pump. The fluid bypass line is also called emergency line. The fluid bypass line is designed in such a way that it conducts the extinguishing fluid pumped by the pump away from the fluid outlets even if the opening element in the test line is in the locking position. The fluid bypass line thus serves to conduct the extinguishing fluid around the opening element away from the at least one fluid outlet and/or from the pipe system comprising the at least one fluid outlet if there is one. Preferably, the bypass line may conduct the extinguishing fluid away from the fluid distribution line towards a drain outlet. Alternatively or additionally, the bypass line may conduct the extinguishing fluid away from the fluid distribution line towards the fluid supply line. Alternatively or additionally, the bypass line may conduct the extinguishing fluid away from the fluid distribution line towards a fluid storage or fluid reservoir configured to store the extinguishing fluid.

Water extinguishing systems of the type mentioned above are subject to the regulations described in VdS 2212, among others. In particular, paragraph 1.3.4 of VdS 2212 provides for weekly inspections of the water extinguishing system by the system operator. Among other things, the weekly tests include a check of the pump start of the pump which is used to pump the extinguishing fluid. For this, a so-called pump test run must be carried out, which must continue until the normal operating parameters of the pump are reached.

In such water extinguishing systems the test line is usually used for this purpose, enabling a pump test to be carried out while preventing the extinguishing fluid from causing weekly flooding of the areas monitored by the water extinguishing system during the weekly required pump test of the pump. This test line can be opened by means of the opening element for the purpose of the pump test run and closed again after the pump test run has been completed. In this way, it is possible to provide a kind of test circuit for the period of the pump test run, thus avoiding flooding of the monitored areas.

In some water extinguishing systems, the test line is configured in such a way that it conducts the extinguishing fluid flowing through it back into a fluid reservoir and/or an intermediate tank which is in fluid connection with the fluid supply line. This means that the extinguishing fluid passing through the test line during the pump test run can still be used by the water extinguishing system.

In some water extinguishing systems, the extinguishing fluid passing through the test line is also conducted into a waste water tank and/or discharged via a waste water pipe and not stored.

The fluid bypass line can also be configured to conduct the extinguishing fluid flowing through it back into the reservoir and/or an intermediate tank. Alternatively, the fluid bypass line may be configured such that the extinguishing fluid passing through it is conducted into a waste water tank and/or a waste water pipe and/or otherwise discharged from the pipe system and is not available to the system again.

According to the prior art, the weekly pump test run of the pump is carried out by hand, i.e. manually, by a person trained to do so. During the pump test run, the test line is first activated by opening the opening element. Subsequently, an activation element, typically a switching element, may then be used to trigger an activation of the pump. In case of a switching element being used as the activation element, this may encompass bringing the switching element from an inactive state into an active state.

The activation of the pump may be automatic or performed manually. The starting pressure, which is the pressure at the time the pump is activated, is then measured and recorded and the pump test run is carried out until the normal operating parameters of the pump drive motor are reached. The test line is then closed again by means of the opening element and no further extinguishing fluid can enter the test line.

When a test run is carried out, there is a risk that, during the test run, a fire occurs and the water extinguishing system is triggered. In such a case, the available amount of extinguishing fluid delivered by the pump is reduced by the amount of water flowing through the open or unclosed test line. This indifferent state has so far prevented the labor-intensive weekly inspections from being automated and leads to an increased risk of an improper supply of the water extinguishing system with extinguishing fluid, for example due to human error. In particular, the need to close the test line manually increases the risk that the person responsible for servicing the sprinkler will actually close it.

In the past, efforts have been made to automate the pump test by providing for a safety measure that allows closing the test line in the event of a fire in order to have the full amount of extinguishing fluid available for fighting the fire event. One such approach is presented in International application WO 2020/035385 A1. The idea here is to provide, in addition to the opening element, a shut-off element for closing the test line in case the water extinguishing system is activated, in particular due to a fire event. By means of this closing, the full amount of extinguishing fluid is readily available to the pipe system of the water extinguishing device and may be used to fight the fire.

Another approach for automating the pump test procedure is presented in European application EP 3 842 101 A1. According to the approach foreseen by this application, the test line is not used anymore for performing the pump test and remains closed during the testing. Instead, the pump test is performed using the fluid from the bypass line. This concept is based on the understanding that the small amount of extinguishing fluid which can be passed through the fluid bypass line is sufficient to prevent the pump from running dry and, for example, overheating during the pump test run. Further, since only a small amount of fluid is used, this does not affect the fire fighting capabilities of the water extinguishing system, thereby allowing the system to remain ready for operation even during the pump test run.

In both cases, the concept of aborting the pump test run in case of an emergency even, such as a fire to be extinguished, is foreseen. For this purpose, the water extinguishing systems of the prior art comprised a control unit that is capable of controlling the pump and, in particular, activating the pump for the purpose of running the pump test run and aborting the pump test run—while typically maintaining operation of the pump for pumping the extinguishing fluid to fight the fire event-if an emergency event, e.g. a fire event, occurs.

As such, an emergency even, such as a fire event or other hazard in an area monitored by the water extinguishing system, may be one reason to abort an otherwise automated pump test run. In that regard, it may be beneficial to provide for a process that allows securely determining whether an event has occurred that requires to abort a pump test run. In that regard, such an event may not only be an emergency event. There may also be other reasons, for example the mere lack of sufficient extinguishing fluid for cooling the pump, that may require the pump test run to be aborted. In some cases there may also be disruptions that might require the pump to be shut down. Hereby, in order to provide a fully automated pump test run, the abortion of the test run and/or the shutting down of the pump also need to be automated, whereby this automation should also ensure that the pump test run is not aborted unnecessarily, i.e. that an appropriate reaction is made with respect to the pump and the pump test run.

Against this background, one object of the present invention is to create a solution which enables the pump test run to be activated and aborted automatically. More particularly, it is an object of the present invention to provide for a solution which allows appropriately reacting to irregularities and/or disruptions during the automated pump test run, thereby allowing for a more sophisticated automated decision on the actions to be taken in view of the occurrences registered during a pump test run.

This task is solved according to the invention by a water extinguishing system of the type mentioned initially, in which the water extinguishing system comprises a plurality of sensors in signal connection with the control unit, wherein each of the plurality of sensors is configured to obtain at least one parameter value of a parameter indicative of an operating state of the water extinguishing system, wherein control unit is configured to receive the at least one parameter value from at least one of the plurality of sensors, to determine, based on an evaluation of the at least one parameter value, at least one pump operation condition and to control a pump operation comprising a pump test run based on the at least one pump operation condition.

In accordance with this solution, a plurality of sensor readings providing information collected at several positions within the water extinguishing system are used to determine at least one pump operation condition, preferably at least two pump operation conditions, on the basis of which the control unit may control the pump operation including the pump test run.

The controlling of the pump operation including the pump test run may particularly comprise an initiating of the pump test run if the evaluation of the parameter values of the parameters as obtained from the sensors allows for the conclusion that the pump test run may be performed without any problems. In this case, it is assumed that the pump operation condition is met, i.e. that it is determined that all requirements necessary for performing the pump test run are fulfilled. On the other hand, the controlling of the pump operation may comprise not initiating the pump test run of the evaluation of the parameter values of the parameters as obtained from the sensor reveals that there are irregularities or disruptions present that make it problematic to perform the pump test run.

Alternatively or additionally, the controlling may encompass aborting the pump operation including the pump test run once it has been started if the evaluation of the parameter values reveals that, while the pump test run could initially have been initiated, in the meantime some occurrence has occurred that makes it necessary to abort the pump test run. The controlling may also encompass running the pump operation including the pump test run until the pump test run is finished and then terminating the pump test run.

The controlling may further, alternatively or additionally, encompass monitoring the progress of the pump operation including the pump test run and providing an indication of the progress as monitored to a central control unit such as a fire alarm centre. In general, the controlling may encompass performing all steps that would otherwise be performed by trained personnel in an automated manner by the control unit.

Hereby, the pump test run may be executed for a certain time frame. This time should be chosen in dependence on the pump properties and selected such as to ensure a proper pump test run. It is also conceivable that the pump test run time is determined during the pump test run procedure itself. In some embodiments, the pump test run time depends on sensor data, preferably the pump test run will be maintained until one or more parameter values from sensors meet a threshold criterion. In some embodiments, such parameter values may comprise any combination of parameter values of parameters indicative of an operating state of the water extinguishing system. In such a case, it can be understood that the final pump test run time is changed or set to be derived from the time between starting the pump and meeting the threshold criteria. If such threshold criteria are not met within another predetermined maximum pump test run time, the pump test run may be aborted. In some embodiments, the pump test run time may be 15 minutes. In some embodiments, it may be shorter, such as 5 minutes, 10 minutes, or anything between 1 second to 15 minutes. In some embodiments, it may be longer, i.e. 15 minutes, such as 20 minutes, 25 minutes or any other value above 15 minutes.

It is noted that the pump test run is, inter alia, used to determine the functionality of the pressure switch, respectively pressure switches, that are used for starting the pump. These pressure switches are typically provided in a redundant manner for sake of security (such as to have a second pressure switch in case a first pressure switch does not work properly).

This redundancy means that both pressure switches should be functional and both pressure switches thus should be subjected to a test performed in the context of the pump test run.

The invention is based on the realization that the automation of the pump operation, and, in particular, the pump test run, requires a continuous monitoring of the operating state of the water extinguishing system. More particularly, the invention is based on the realization that the water extinguishing system and its operating state are fluent and that it cannot be assumed that, just because the operating state was appropriate for a pump test run when the pump test run was started, it remains appropriate for the entire length of the pump test run.

Hereby, the operating state of the water extinguishing system refers to the state in which the water extinguishing system currently resides. This state may for example correspond to an idle state in which the water extinguishing system is not performing any emergency procedures and is also not otherwise occupied. In this state, the water extinguishing system should be in an emergency readiness state, i.e. should be capable of reacting to an emergency quickly and appropriately, once such reaction becomes possible. The operating state may, however, also be state in which something is not according to plan.

As an example the water extinguishing system may be in an alarm state due to a reduced pressure of fluid, such as air or gas within the pipe network of the water extinguishing fluid.

This reduced pressure may particularly be determined using a respective pressure switch provided in the system. In these cases, the water extinguishing system may particularly comprise a valve, such as an alarm valve, typically implemented as a wet or dry alarm valve. In case a valve element is also present in the system, the pressure switch may e.g. provided downstream of the valve element.

As a further example, the water extinguishing system may be in an alarm state due to detecting a hazard in an area monitored by the system which may e.g. be detected by automatic fire detectors. One such hazard may e.g. be an emergency event such as a fire event or the like. In case a valve element is present in the system, such an alarm state may typically be for a well-known deluge valve.

The pump operation condition may be based on an evaluation, by the control unit, of at least one parameter value of a parameter obtained from at least one of the plurality of sensors. Such evaluation may e.g. encompass obtaining the parameter values and comparing the parameter values to a threshold and/or a range in order to determine whether the parameter values are within standard ranges and/or above or below standard values or whether they are outside these standard ranges and/or below or above said standard values. If it is determined that the parameter values are outside the standard given, it is concluded that an irregularity and/or disruption has occurred which may require adjusting the pump operation. In such a case, the control unit may then control the pump operation accordingly.

In this context, the term pump operation condition refers to any condition, determined on the basis of the parameter value or parameter values given, under which the pump may continue to operate. As an example, if there is a pressure sensor for measuring the pressure of the extinguishing fluid in the fluid distribution line and a temperature sensor for measuring the temperature of the pump and if the pressure of the extinguishing fluid is above a pre-set threshold above which proper operation of the water extinguishing system is ensured and if the temperature of the pump is below a pre-set threshold below which it may be assumed that the pump does not overheat, this, in combination, may be viewed as a pump operation condition under which the pump test run may continue. On the other hand, if the pressure sensor indicates a pressure drop, leading to the pressure falling below the threshold this may be seen as an indication that the pump test run should be aborted. If such pressure drop is measured prior to starting the pump, this may—irrespective of the temperature of the pump measured—be a sign to not start the pump test run at all, but instead start the pump operation in order to properly pump water in the direction of the fluid outlets.

Overall, the pump operation condition may particularly take into account whether a pump test run is already active or whether the pump test run has to be initiated. Hereby, the conditions for the latter one may be different than the conditions for the first one. Accordingly, in some embodiments of the water extinguishing system the at least one pump operation condition may comprise one or more of a pre-start condition, wherein the pre-start condition is used by the control unit to determine whether to initiate the pump test run, and/or a post-start condition, wherein the post-start condition is used by the control unit to determine whether to continue the pump test run after the pump test run has been initiated.

In this context, the term pre-start condition may particularly refer to a pump operation condition that is used prior to initiating the pump in order to decide upon whether or not the pump shall be started to perform the pump test run. To put differently, the pre-start condition is used to decide whether the pump test run shall be started at all or whether it should be deferred from starting it.

By contrast, the term post-start condition refers to a condition regarded after the pump operation, in particular the pump test run, has already been started. Here, the post-start condition is used to decide on whether or the pump test run shall be continued—in case the post-start condition is met- or aborted—in case the post-start condition is not met.

The concept of distinguishing the pump operation conditions into pre-start and post-start is based on the realization that, depending on whether or not the pump is already running, and, in particular, already performing the pump test run, different criteria may apply in order to decide whether the pump test run shall be performed. As an example, measuring the temperature at the pump does not make a lot of sense prior to starting the pump test run—in this case, the pump cannot have a too high temperature—but may be a valuable decision criterion once the pump test is running-if the pump runs too high, the test run should be aborted in order to avoid damaging the pump.

The present invention takes account of these differences by categorizing the pump operation conditions into pre-start and post-start. In that regard, it shall be noted that, although only one pre-start condition is mentioned, there may be multiple pre-start conditions to be considered. Similar, also only one post-start condition is mentioned herein above, there may be multiple post-start conditions used by the control unit to decide upon the initiation, continuation and/or abortion of the pump test run.

In some embodiments of the water extinguishing system, the plurality of sensors may comprise at least one of a pressure sensor and/or a temperature sensor and/or a flow sensor and/or a vibration sensor. It shall be understood that each of these sensors may be provided alone or the sensors or a subset thereof may be provided in combination. As an example, the water extinguishing system may comprise a pressure sensor only.

Alternatively or additionally, the water extinguishing system may comprise a temperature sensor. Again alternatively or additionally, the water extinguishing system may comprise a flow sensor in combination with the temperature sensor and the pressure sensor or only one of the two. Alternatively or additionally, the water extinguishing system may also be provided with a vibration sensor. It shall further be understood that there may be more than one pressure sensor and/or temperature sensor and/or flow sensor and/or vibration sensor. Further, there may be additional sensors for measuring further aspects such as electrical current, opening and closing intervals or the like.

In some modifications, the plurality of sensors may comprise at least one pressure sensor configured to determine one or more of a pressure of the extinguishing fluid at or within the fluid supply line and/or a pressure of the extinguishing fluid at or within the fluid distribution line and/or a pressure of the extinguishing fluid at or within a fluid storage, the fluid storage in fluid connection with one or more of the fluid supply line and/or the fluid distribution line and/or a pressure in a bypass line branching from the distribution line to conduct the extinguishing fluid away from the distribution line.

In some embodiments, the plurality of sensors may particularly comprise one or more pressure sensors. These pressure sensors may be configured to determine the pressure of the extinguishing fluid conducted from a reservoir or storage toward the pump through the supply line and conducted though the distribution line from the pump to the at least one fluid outlet. The pressure sensors may hereby particularly be provided at or within the fluid supply line. In some embodiments, the pressure sensors may particularly be provided at the pump inlet. Alternatively or additionally, the pressure sensor may be provided at or within the fluid distribution line, i.e. downstream of the pump. In some embodiments, the pressure sensors may particularly be provided at the pump outlet. Alternatively or additionally, in case a valve element is provided in the water extinguishing system, a respective pressure sensor may be provided at the valve inlet and/or at the valve outlet.

By providing a respective pressure sensor at these positions, a measurement is enabled to determine whether the fluid conducted through the fluid supply line and the fluid distribution line and pumped by the pump has sufficient pressure in order to ensure proper functioning of the water extinguishing system and, in particular, emergency readiness of the water extinguishing system. Furthermore, the pressure may be used as an indication for the alarm state of the water extinguishing system. As an example, a sudden pressure drop at the fluid distribution line may be indicative of the water extinguishing system having been activated as the exiting of the extinguishing fluid through the at least one fluid outlet will cause the pressure to be reduced within the fluid distribution line.

In order to determine the pump operation condition, in particular the pre-start and/or post-start condition, the control unit may evaluate the sensor readings and determine whether the water extinguishing system is in a readiness state in which no irregularities and/or disruptions are present or in an exception state, such as an alarm state, in which something irregular and/or disruptive, such as an emergency event or a leakage, has been detected. Hereby, the fulfilment or non-fulfilment of the pump operation condition and, hence, the decision of whether or not to initiate or continue the pump test run, may particularly be determined by comparing the sensor readings to a standard range or a standard threshold value that provides for a pre-set indication as to what is the norm and what is an exception. As a general rule, in case of any exception, the control unit enforces a corresponding action to allow for an appropriate reaction by the water extinguishing system.

In some embodiments, there may also be at least one pressure sensor provided and configured to measure the pressure of the extinguishing fluid at or within a fluid storage, such as a reservoir or the like. The fluid storage may be in fluid connection with the fluid supply line and/or the fluid distribution line. In some embodiments, the fluid storage may be pressurized and this pressure may be determined by a respective pressure sensor. It may further be beneficial that the fluid storage is appropriately pressurized. This, on the one hand, ensures proper operation in case of an emergency and, on the other hand, also increases the amount of extinguishing fluid that may be provided in these reservoirs. With respect to the pump operation condition, it may be used as an indicator whether a pump test run can be started and/or continued, if it has already been started. As a rule, such start or continuation should only take place if the pressure in the fluid storage is above a threshold value such as to ensure that an appropriate amount of extinguishing fluid may be pumped in order to avoid damage to the pump.

In some embodiments, one or more pressure sensors may be provided which allow measuring a pressure in the bypass line branching from the fluid distribution line to conduct the extinguishing fluid away from the fluid distribution line. These pressure sensors may be particularly beneficial in case the pump test run is performed over the bypass line. This is the case since the pressure in the bypass line is typically indicative for the amount of fluid conducted through the bypass line and, hence, available to cool the pump during the pump test run. As such, one pump start condition that may be determined based on the evaluation of the sensor reading here is whether or not the pressure of the extinguishing fluid within the bypass line is above a certain value, such that sufficient extinguishing fluid is provided to the pump via the bypass line.

Further, the pressure sensors may be used to determine the pressure in the overall system, thereby allowing for drawing conclusions on the general operation state of the water extinguishing system. Hereby, the pump operation condition may be that the pressure readings should indicate that the water extinguishing system is in a readiness state rather than an alarm state in order to initiate the pump test run or continue performing the pump test run.

In some embodiments, in particular but not exclusively in those where the pump may be a diesel pump, a pressure sensor may be provided to determine the pressure at an oil storage of the pump. The pressure measurement may hereby be used to determine whether the oil still has enough pressure to properly oil the motor such as to prevent the motor from damages. However, if the pressure falls below a given threshold, the control unit may determine that a post-start condition is not met anymore and abort the pump test run.

In some embodiments, the plurality of sensors may comprise at least one temperature sensor configured to determine one or more of: a temperature of the extinguishing fluid at the pump inlet and/or a temperature of the extinguishing fluid at the pump outlet and/or a temperature at the housing of the pump and/or a temperature of a room in which the pump is provided and/or a temperature of a rotary shaft of the pump and/or a temperature of an oil storage of the pump and/or a temperature of a cooling liquid of the pump, in particular, but not exclusively for those cases where the pump may comprise a diesel pump.

In some embodiments, one or more temperature sensors may be provided in addition or as an alternative to the pressure sensors. Such a temperature sensor may preferably be located at or within the pump. In this context, at or within means that the pump may have a temperature sensor provided in its vicinity or within itself. In that regard, in the vicinity may particularly be understood as referring to the area at the pump inlet and/or at the pump outlet. In some embodiments the temperature sensor may be arranged in particular at the pump outlet and may be configured to measure the temperature of the pump directly or to determine it indirectly by measuring the temperature of the extinguishing fluid pumped by and exiting from the pump. The temperature value determined in this way can then be compared with a corresponding threshold value for evaluation. In particular, this threshold value can be a maximum value for a temperature of the pump and/or of the extinguishing fluid pumped by the pump, i.e. a corresponding temperature threshold value. If said maximum value is exceeded, it can be assumed that the pump would overheat if the pump test run continues. Therefore, the control unit may preferably be configured to abort the pump test run in such a case or, alternatively, not to start the pump test run at all if, prior to the start of the pump, it is registered that the temperature threshold value is already exceeded. As such, the temperature may be used as both, a pre-start condition and a post-start condition. In some embodiments the temperature sensor may also be arranged inside the pump and measure the pump temperature from there. In this case, as well, the control may be based on a temperature threshold value comparison. In any case, the temperature threshold value may be selected in dependence on the particular pump and/or the particular type of pump and/or the particular extinguishing fluid, based on which temperature is determined and base on the position at which the temperature is determined.

In some embodiments, a temperature sensor may be provided such as to determine a temperature of the extinguishing fluid also or solely at the pump inlet. The temperature of the extinguishing fluid at the pump inlet may also assist in drawing conclusions on the pump state of the pump. As an example, if the extinguishing fluid at the pump outlet shows a higher temperature than measured at the pump inlet, this may also allow to conclude that the pump is heating up and is not sufficiently cooled. This may e.g. be an indicator that not enough extinguishing fluid is pumped by the pump. As such, the pump operation condition may be that, if the temperature differential between the temperature at the pump inlet and the pump outlet is above a certain threshold value, the pump test run is aborted such as to avoid overheating of the pump.

Similarly, the measurement of the temperature at the housing of the pump may be used to determine a pump operation condition that may allow to decide whether or not to about a pump test run: If the temperature of the housing is too high, the control unit may conclude that the pump is about to overheat and abort the pump test run.

It may further be possible to measure the temperature of a room in which the pump is provided. This measurement may be used as a pump operation condition and, in particular, both as a pre-start or post-start condition. As an example, if the temperature of the room in which the pump is provided is already very high, a comparison with a threshold value may yield that the extinguishing fluid (whose temperature may also have been measured) would not sufficiently cool the pump during the pump test run. Accordingly, it may be concluded that the pump test run should not be initiated at all. In this case, the room temperature value has been used to determine a pre-start condition which has yielded that the requirements for a start of the pump are not present.

In some embodiments, a temperature sensor may also be used to determine the temperature of a rotary shaft of the pump. Preferably, the temperature sensor may be provided close to the rotary shaft of the pump and may measure the temperature of the extinguishing fluid leaking from a sealing member enveloping the shaft. Alternatively or additionally, a sensor may be provided for measuring leakage at the sealing member. Again, these measurements may be used to evaluate whether a pre-start condition is met and/or a post-start condition is met. As an example, if the temperature sensor indicates a temperature reading that is higher than a particular threshold already prior to the starting of the pump test run, this may be used by the control unit to determine that a pre-start condition is not met and, hence, may lead the control unit to prevent initiating the pump test run. On the other hand, if the temperature reading indicates a temperature below the threshold prior to the start of the pump test run, this may cause the control unit to consider that the pre-start condition is met and, hence, initiate the pump test run. However, if subsequent readings during the test run indicate an increase of the temperature above the threshold, the control unit may find that the post-start condition is not met anymore and abort the pump test run.

In some embodiments, in particular, but not limited to those where the pump is provided as a diesel pump, the temperature sensor may be used to determine a temperature of an oil storage and/or a temperature of a cooling liquid of the pump. That is, one or more temperature sensors may also be provided to determine whether the oil used for the pump is at an appropriate temperature and/or whether a cooling liquid, such as cooling water, used for cooling the pump is an appropriate temperature. If either one of these temperatures is determined to be above a certain threshold, this may mean that the pump is about to be damaged and, hence, the control unit may find that the post-start condition is not met anymore and abort the pump test run.

Similar considerations apply with respect to the leakage. If the leakage is too high, it may be decided that either the pre-start condition or the post-start condition or both conditions are not fulfilled, leading to a non-starting or an abortion of the pump test run. Alternatively or additionally, a minimum leakage at the sealing member may be required for sufficient cooling of the rotary shaft. If the leakage is too low to allow for sufficient cooling of the rotary shaft, it may be decided that a pre-start condition is not met and/or a post-start condition is not met.

In some embodiments, the plurality of sensors may comprise at least one flow sensor configured to determine one or more of a flow rate of the extinguishing fluid in the fluid supply line and/or a flow rate of the extinguishing fluid in the fluid distribution line and/or a flow rate within a bypass line branching from the fluid distribution line to conduct the extinguishing fluid away from the distribution line and/or a flow rate of a cooling liquid of the pump.

In some embodiments, the plurality of sensors may comprise one or more flow sensors that are configured to measure a parameter indicative of the fluid flow within the water extinguishing system, in particular the flow rate through the lines thereof. Hereby, the flow sensor may particularly be provided in the fluid supply line or the fluid distribution line. Alternatively or additionally, a sensor may be provided in the bypass line that branches from the fluid distribution line or a line fluidly connected to the fluid distribution line in order to conduct the extinguishing fluid away from the fluid distribution line, preferably around the opening element of the test line as previously discussed.

In some embodiments, a flow sensor may additionally or alternatively be provided to determine the flow and/or flow rate of a cooling liquid used for cooling the pump. This cooling liquid may particularly be water or a mixture including water. In case the flow rate drops below a certain threshold value, it may be assumed that the pump cannot be properly cooled anymore as there is too little cooling liquid provided per time frame. This may cause the pump to heat up and be damaged. Accordingly, control unit may find that a post-start condition is not met anymore and abort the pump test run.

In general, flow rates may be used, by the control unit, to determine a pump operation condition, in particular as a post-start condition. More specifically, the measured flow rates may be compared with a respective threshold indicating a standard flow rate. If the flow rate meets the threshold or is above it, it can be assumed that the fluid flow through the respective lines is sufficient and, in particular, may be used to cool the pump during the pump test run. If the flow rate falls below the threshold, this may mean that the pump is not sufficiently cooled anymore and, hence, the pump test run should be stopped. As such, the control unit may use the flow rate to determine whether a post-start condition is met—in case sufficient flow rate is detected- or not—in case the flow rate detected is insufficient, i.e. below the threshold- and control the pump test run in accordance with this determination.

In some embodiments, the plurality of sensors may comprise at least one vibration sensor configured to determine one or more of a vibration of the pump and/or a vibration of a pipe along the distribution line. Preferably, the vibration sensor may be provided at the pump housing or the housing of a pipe along the fluid distribution line. Such a vibration sensor may be used to determine the vibration of the pump and/or the pipes connected to the pumps during pump operation. A change in vibration may be indicative of an irregularity and/or a disruption in the water extinguishing system. For example, if cavitation and/or deposits occur in the fluid bypass line and/or the fluid supply line and/or the fluid distribution line, the vibration of the pump or the respective pipes may change. The vibration sensor may detect these changes compared to the threshold value pre-set, e.g. based on experience or on values registered during operation without cavitation and/or deposit. The vibration sensor may then signal this discrepancy to the control unit which the control unit may take as an indication that the pump test run should be aborted.

In some embodiments, the plurality of sensors may comprise at least one first sensor configured to determine one or more of an activation state of a pressure switch at or within the distribution line and/or a response time of a pressure switch at or within the distribution line and/or an operating current of the pump, wherein the pump comprises an electrical pump, and/or an operating current state of the pump, wherein the pump comprises an electrical pump, and/or leakage from the fluid supply line and/or leakage from the fluid distribution line and/or a determination of a fuel level of the pump, wherein the pump comprises a diesel pump, and/or a determination of an oil level in an oil storage of the pump, and/or a determination of a cooling liquid of the pump, and/or a motor speed of the pump, wherein the pump comprises a diesel pump.

In some embodiments, further sensors may be provided as parts of the plurality of sensors. In some embodiments, these further sensors may comprise a first sensor configured to determine an activation state of a pressure switch that has been provided at or within the fluid distribution line. Such pressure switches may be used to change from a first state to a second state in response to a certain pressure change acting on the pressure switch. As an example, in the event of fire, the pressure switch at or within the fluid distribution line may switch to an activation position. This pressure switch may be used to activate the pump, thereby leading to an arrangement in which, in the event of a fire, the pump is automatically activated by the pressure switch. The monitoring of the activation state on the pressure switch by a respective first sensor may thus be considered as providing for a pump operation condition in which, upon activation, the pump test run may be aborted or prevented from being initiated as it may be assumed that this activation state change may be due to an emergency event, such as a fire event.

In some embodiments, these further sensors may comprise a first sensor configured to determine a response time of a pressure switch at or within the distribution line. That is, a first sensor may be used to monitor the time elapsed between the pressure change and the switching of the pressure switch to a different state.

In some embodiments, the further sensors may also comprise a current sensor which is configured to determine and/or monitor an operating current of the pump in the event that the pump comprises or corresponds to an electrical pump. In some embodiments, the sensor may additionally or alternatively be configured to determine and/or monitor an operating current state of the pump, in particular if the pump comprises or corresponds to an electrical pump. This may allow to draw conclusions on the state of the pump. In particular, if it is determined that the current and/or the current state does not comply with the expected values, it may be decided to abort a pump test run and/or defer from starting one to begin with.

In some embodiments, the further sensors may also comprise a leakage sensor configured to determine and/or monitor leakage from the fluid supply line and/or from the fluid distribution line. Such leakage detection may be particularly beneficial, as it not only allows to draw conclusions regarding the operational readiness of the water extinguishing system, but may also be used as a guidepost for determining whether a pump test run may be safely executed. In particular, it may be used to determine whether there is enough extinguishing fluid to cool the pump during a pump test run, i.e. enough extinguishing fluid to safely run the pump test run. As such, the leakage detection parameters may be used to determine a respective pump operation condition that may either be a pre-start condition and/or a post-start condition. In any case, this condition is checked against a pre-set threshold in order to determine whether the leakage is smaller or higher than the threshold. If it is higher, this may be evaluated to mean that the pre-start condition and/or the post-start condition is not met and prevent the execution of a pump test run.

In some embodiments, in particular but not limited to those where the pump comprises a diesel pump, one or more sensors may be provided to determine a fuel level and/or an oil level in an oil storage and/or a cooling liquid level in a respective cooling liquid reservoir of the pump. These aspects may allow determining whether the pump may be properly run and cooled during operation. If the levels are below a certain threshold, this may mean that either the proper running or the proper cooling or both cannot be ensured. Hereby, it may be detected prior to starting the pump or during a pump test run that this is the case. Hence, the control unit may use the comparison to a respective threshold as both, a pre-start condition (if the problem is detected prior to starting the pump) or a post-start condition (if the problem occurred during pump operation).

Alternatively or additionally, in particular for embodiments where the pump comprises a diesel pump, one or more sensors may be provided which allow to determine a motor speed of the pump. Here, the motor speed should be in a standard range as typically pre-determined for a pump. In case it is outset this range, i.e. below a certain threshold or above a certain threshold, this may mean that something is not working properly which may prompt the control unit to determine that a post-start condition is not met anymore and to abort the pump test run.

In some embodiments, the at least one pump operation condition may comprise the pre-start condition; and the control unit may be configured to allow initiating the pump test run if the pre-start condition is met, and prevent initiating the pump test run if the pre-start condition is not met.

In some embodiments the at least one pump operation condition may particularly comprise a pre-start condition, i.e. a condition used to determine whether to start the pump test run to begin with or whether to prevent starting such a pump test run. The pre-start condition may particularly take account of the fact that there may be occurrences in which it may not be beneficial to start the pump test run.

In accordance with some embodiments, the pre-start condition may be determined by evaluating one or more parameter values of parameter obtained from the plurality of sensors. One such sensor may be a first sensor which has monitored the activation state and/or the response time of a pressure switch at or within the fluid distribution line. In particular, in case it is determined that the pressure switch has been activated due to a fire event, this may be counter indicative of starting a pump test run to begin with. As such, a certain pre-start condition for starting the pump test run is not met. Similarly, a certain response time of the pressure switch may be indicative for the fact that the pump test run cannot safely be executed and, hence, it may be beneficial to not execute the pump test run at all in such a case. This, again, means that a certain pre-start condition is not met.

Further, the temperature at the pump housing may provide for a parameter that provides insights into the question of whether or not to start the pump test run. If the temperature at the pump housing is already very high, it may not be beneficial to start the pump test run. Accordingly, this may lead to the pre-start condition not being fulfilled and the pump test run being prevented, by the control unit, from initiating.

Similarly, the room temperature may be used for deriving a pre-start condition. In this case, the room temperature may particularly exceed a certain threshold, causing the pump to be prevented of starting the pump test run. This may be used for avoiding overheating of the pump.

In some embodiments, a pressure of the extinguishing fluid within the fluid distribution line at the valve outlet may be used to determine whether or not the pre-start condition is met.

For the case where the valve element comprises or corresponds to a wet alarm valve, such fluid may particularly be a liquid, such as water or a water-extinguishing-liquid mixture. For the case where the valve element comprises or corresponds to a dry alarm valve, such fluid may particularly correspond to a gas, in particular air, whose pressure is measured. In particular, it may be a pre-start condition that the pressure reaches a certain threshold as a pressure below said threshold may be indicative of too severe leakage in the system and/or an emergency activation of the water extinguishing system, both of which might be used to decide against starting a pump test run.

In some embodiments, the sensor reading used to decide upon the pre-start condition may correspond to a leakage measurement, preferably performed at the fluid supply line or the fluid distribution line. The leakage may particularly be measured in terms of a fluid drop rate. The measurement may be compared to a range or threshold value below which the leakage is negligible. If the threshold value is exceeded, however, the leakage is deemed to severe, leading to the pump test run being prevented from being started.

In a modification, the control unit may be configured to provide, in response to the pre-start condition being met, a trigger signal causing a switching element of the pump to change an activation state to an active state. In yet a further modification, the pre-start condition may comprise an indication of a time elapsed between providing the trigger signal and the change of the activation state.

In some embodiments, the pressure switch may be connected to the pump, whereby a pressure drop may be artificially initiated, for example by opening a controllable fluid outlet at or near the pressure switch in response to the trigger signal, or occur automatically. This pressure drop may cause the pressure switch to change its activation state. This change may particularly correspond to an indication that the pre-start condition is met. In such a case, the control unit may provide a trigger signal which, in turn, switches the pump into an active state. In some embodiments, this switching may be performed by means of a pressure switch connected to the pump. In some embodiments, the switching may be performed by means of a signal provided from the control unit to the pump. In any case, the switch may be indicative of the pre-start condition being met and the trigger signal may be issued to start the pump.

In some embodiments, the system further comprises a sensor capable of determining the response time of the pump, respectively its start switch, in response to the trigger signal. The response time may hereby be measured as the time frame between providing the trigger signal and changing the activation state of the pressure switch. This response time may be indicative of the readiness of the water extinguishing system and may be considered as indicating that the pre-start condition is met.

In some embodiments, the control unit may particularly be configured to determine whether or not the pre-start condition is met. If this is the case, the control unit is configured to allow initiating- or initiate itself—the pump test run. If the pre-start condition is not met, the control unit is configured to prevent initiating the pump test run, such as to avoid damages to the pump.

In some embodiments, the at least one pump operation condition may comprise the post-start condition, and the control unit may be configured to control the pump test run based on the post-start condition, wherein the controlling comprises allowing the pump test run to continue if the post-start condition is met and aborting the pump test run if the post-start condition is not met.

In some embodiments, the post-start condition is determined, as described herein above, based on an activation state and/or a response time of the pressure switch at or within the fluid distribution system.

Similarly, as discussed herein above, the post-start condition may be determined using a measurement of the pressure of the extinguishing fluid at or within the fluid supply line, in particular at the pump inlet. This may allow determining whether the extinguishing fluid is entering the pump with a pressure sufficient to provide for an effective fire protection in case the water extinguishing system is activated.

In some embodiments, a further parameter considered when determining the post-start condition is the temperature of the extinguishing fluid at the pump inlet which may indicate the temperature at or within the pump and may be used to determine whether the pump could be sufficiently cooled during the pump test run. If this is not the case, the post-start condition may indicate that the pump test run should be aborted.

In some embodiments, further parameters for determining the post-start condition may encompass the pressure of the extinguishing fluid at or within the fluid distribution line and the fluid supply line, preferably at the pump outlet, i.e. in the fluid distribution line. The post-start condition may further encompass the pressure of the extinguishing fluid at or within the distribution line, in particular at the pump outlet or at the valve inlet. In particular, if the pressure is too low, it may be considered that the pump test run shall be aborted.

Further parameters may encompass the flow rate of the extinguishing system in both the fluid supply line and the fluid distribution line. Based on a measurement of the flow rate, it may be determined whether there is any leakage in the system and, even if there is not, if there is any damaged part of the system that is in need of repair. In such a case where the flow rate of the extinguishing fluid is in the fluid supply line and the fluid delivery line, it is decided on whether or not the pump test run should be continued. In some embodiments, there is also a vibration sensor provided which is configured to measure vibration of the pump, preferably of the pump housing, and/or the vibration of a pipe forming a part of the distribution line. This measurement may be considered to decide upon whether or not the test run should be continued. In particular, a change in vibration may be indicative of an irregularity and/or a disruption in the water extinguishing system, for example due to cavitation and/or deposits in the fluid bypass line and/or the fluid supply line and/or the fluid distribution line which might negatively affect the pump test run which, thus, should be aborted.

In further embodiments, a leakage sensor is provided for measuring leakage, preferably in the form of fluid drop rate, from the fluid supply line and/or the fluid distribution line. This may allow to abort the pump test run in case there is too much leakage and it may be considered that there is too little extinguishing fluid provided to the pump during the pump test run in order to properly cool the pump.

In some embodiments, a current sensor may alternatively or additionally be provided to monitor an operating electrical current and/or an operating electrical current status of the pump in the case where the pump is an electrically operated pump. The determination of the operating electrical current and/or the operating electrical current status may allow to draw conclusions regarding the pump's functionality and may thus allow to determine, as a post-start condition, whether the pump test run should be continued or aborted.

In some embodiments, a pressure sensor may, alternatively or additionally, be provided to determine a pressure of the extinguishing fluid at or in a pressurized fluid storage tank, such as a fluid reservoir the pressurized fluid storage tank being in fluid connection with supply line, the pump and the distribution line. Since the pressure of the extinguishing fluid is an important measure to determine whether a pump test run may safely be executed, this monitoring is particularly desirable in order to determine whether or not to continue or abort the pump test run.

In some embodiments, there may also be temperature sensor provided for measuring the temperature of a rotary shaft of the pump or, more particularly, of the extinguishing fluid as leaking from a sealing member enveloping the rotary shaft, and/or a leakage sensor providing for measuring the leakage, preferably in the form of fluid drop rate, at the sealing member. As such, a sensor may be provided to monitor the sealing member thereby allowing to conclude whether the sealing member enveloping the rotary shaft is in a condition in which the pump test run may be safely executed.

In some embodiments, the sensors may further encompass a pressure sensor and/or a flow rate sensor and/or a combined sensor for measuring pressure and flow rate at or within the bypass line branching off from the distribution line and being configured to conduct the extinguishing fluid away from the fluid distribution line towards a drain outlet and/or the supply pipe system. In particular, if the pressure and/or flow rate are determined to be too low to safely execute the pump test run, it may be aborted in response to a post-start condition not being met.

According to the above aspects, a number of sensor readings is used to determine whether a pump test run shall be started and, once started, whether the pump test run shall be continued. In particular, the sensor readings are used to derive parameters that may be suitable to provide an indication as to whether or not to start the pump test run and/or, upon being started, to keep it running or abort it, depending on the sensor readings provided by the plurality of sensors.

A further aspect of the invention relates to a method for controlling a pump operation comprising a pump test run in a water extinguishing system, said water extinguishing system comprising a fluid supply line in fluid connection with a fluid distribution line for distributing the extinguishing fluid to at least one extinguishing fluid outlet, a pump comprising a housing, a pump inlet in fluid connection with the fluid supply line and a pump outlet in fluid connection with the fluid distribution line, a control unit, and a plurality of sensors in signal connection with the control unit, the method comprising: obtaining, by at least one of the plurality of sensors, at least one parameter value of a parameter indicative of an operating state of the water extinguishing system, receiving, at the control unit, the at least one parameter value from at least one of the plurality of sensors, evaluating, at the control unit, the at least one parameter value, determining, at the control unit, based on the evaluating, at least one pump operation condition and controlling, by the control unit, the pump operation comprising the pump test run based on the at least one pump operation condition.

Also in this case, the water extinguishing system may comprise at least one valve element provided within the fluid distribution line comprising a valve inlet in fluid connection with the pump outlet and a valve outlet in fluid connection with the at least one extinguishing fluid outlet, wherein the method comprises closing the valve element during the pump test run and opening the valve element upon determination of an alarm state.

In some embodiments, the at least one pump operation condition may comprise one or more of a pre-start condition, wherein the pre-start condition is used by the control unit to determine whether to initiate the pump test run, and/or a post-start condition, wherein the post-start condition is used by the control unit to determine whether to continue the pump test run after the pump test run has been initiated. In some embodiments, the at least one pump operation condition may comprise the pre-start condition and the controlling may comprise one or more of allowing initiating the pump test run if the pre-start condition is met and/or preventing initiating the pump test run if the pre-start condition is not met. In some embodiments, the method may further comprise providing, by the control unit, a trigger signal in response to the pre-start condition being met and changing an activation state of a switching element of the pump to an active state based on the trigger signal. In some embodiments, the at least one pump operation may comprise the post-start condition and the method may further comprise controlling, by the control unit, the pump test run based on the post-start condition, wherein the controlling comprises allowing the pump test run to continue if the post-start condition is met, and aborting the pump test run if the post-start condition is not met.

Although the preferred embodiments of the invention have been explained above in relation to the aspect of the water extinguishing system, these preferred embodiments are equally preferred embodiments of the method described herein below.

The invention is described in more detail below with reference to the attached figures and using preferred embodiment examples. The figures show:

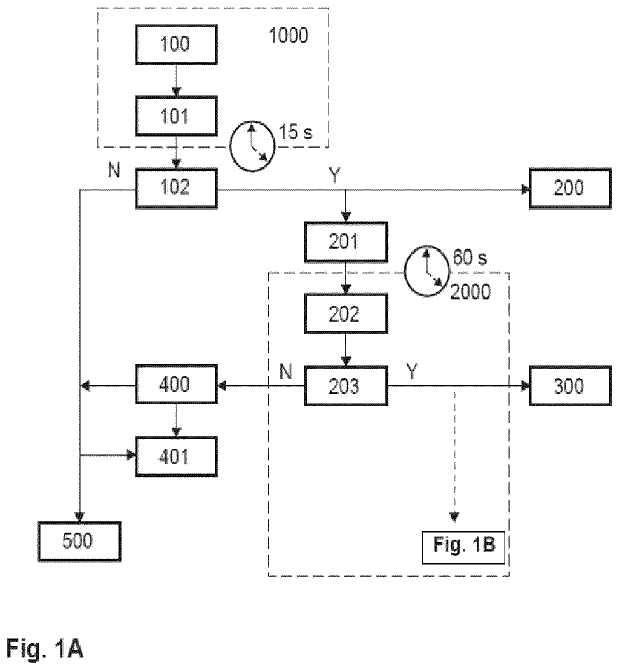

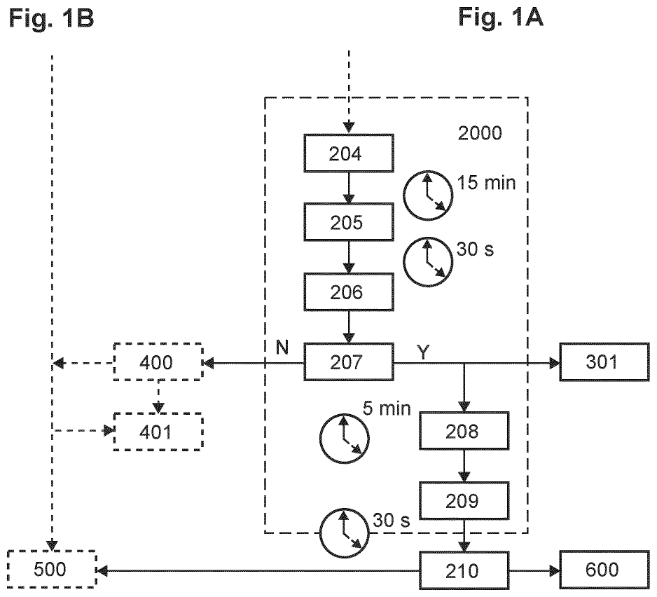

FIG. 1A a schematic flow chart of a method for performing a pump test run according to a preferred embodiment.

FIG. 1B the continuation of the flow chart representing the method for performing a pump test run according to FIG. 1A.

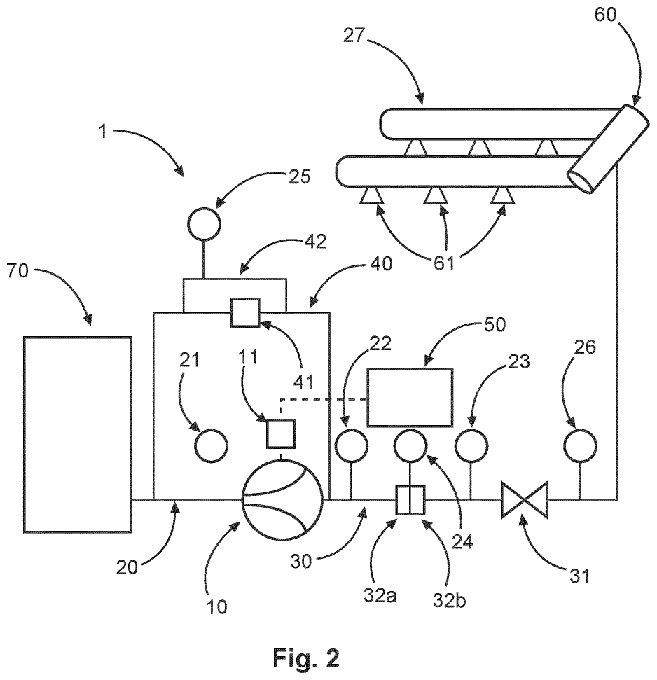

FIG. 2 a schematic diagram of a water extinguishing system in which the method as explained in relation to FIGS. 1A and 1B may be implemented.

FIGS. 1A and 1B illustrate a schematic flow chart representing a method for controlling pump operation, in particular for performing a pump test run, according to an embodiment of the invention. Such a method may particularly be performed by a control unit according to the invention. The method may be implemented to be performed in said control unit by means of software or hardware or a combination thereof. It is further noted that the control unit may be provided as a central unit or may be implemented as multiple elements distributed in the water extinguishing system. That is, in some embodiments, multiple instances of the control unit may exist. In some embodiments, the control unit may be a dedicated unit provided for the purpose of controlling the pump operation and, in particular, the pump test run. In some embodiments, the control unit may be provided as part of the pump. In some embodiments the control unit may be a part of a central control device, such as a fire protection control centre. The control unit may further be part of another element of the water extinguishing system as long as it is capable of performing the steps according to the method as described in relation to FIGS. 1A and 1B.

Coming back to FIG. 1A, the method starts at step 100 with the pump operation being initiated. At step 101, a request is sent to inquire whether certain pump operation conditions are fulfilled. In particular, since the pump operation is just being initiated, the request is used to inquire whether pre-start conditions 1000 are fulfilled, i.e. the status of the conditions for starting and/or preventing to start pump operation. As such, steps 100 and 101 encompass the time at which pre-start conditions 1000 are reviewed.

These pre-start conditions 1000 may be determined on the basis of the sensor readings of the plurality of sensors in the water extinguishing system. In particular, the pre-start conditions 1000 that are checked may be determined by evaluating one or more parameter values of parameters obtained from the plurality of sensors.

In the exemplary embodiment of FIG. 1A, these pre-start conditions may encompass checking the activation state and/or the response time of a pressure switch at or within the fluid distribution line. Hereby, the pressure switch activation may be indicative of a fire event which may prevent the pump test run and, hence, lead to the conclusion that the pre-start condition is not met. The response time of the pressure switch may be indicative for the fact that the pump test run cannot safely be executed and, hence, it may be beneficial to not execute the pump test run at all in such a case. Thus, the proper activation of the pressure switch may be considered a pre-start condition for the pump test run.

Another parameter value reviewed in the exemplary embodiment of FIG. 1A in order to check whether pre-start conditions are met is the temperature at the pump housing. If the temperature at the pump housing is already very high, it may not be beneficial to start the pump test run. Accordingly, this may lead to the pre-start condition not being fulfilled. On the other hand, if the temperature is within a certain acceptable range, the pre-start condition may been considered as being fulfilled.

Furthermore, in the exemplary embodiment of FIG. 1A, a sensor reading is provided that indicates the room temperature of the room in which the pump is situated. Hereby, in case the room temperature exceed a certain threshold, the pump is prevented of starting the pump test run.

In the embodiment of FIG. 1A, another pre-start condition considered relates to the pressure of the extinguishing fluid within the fluid distribution line at the valve outlet. In particular, it may be a pre-start condition that the pressure reaches a certain threshold as a pressure below said threshold may be indicative of too severe leakage in the system and/or an emergency activation of the water extinguishing system, both of which might be used to decide against starting a pump test run.

Yet another sensor reading used to decide upon the pre-start condition being met in FIG. 1A is a leakage measurement performed at the fluid distribution line. Hereby, the leakage is measured in terms of a fluid drop rate. This measurement may be compared to a range or threshold value below which the leakage is negligible. If the threshold value is exceeded, however, the leakage is deemed to severe, leading to the pump test run being prevented from being started.

In the exemplary embodiment of FIG. 1A, the method is implemented such as to have the request last for a certain time. In the exemplary embodiment of FIG. 1A, the time frame for sending the request, designated request time, corresponds to 15 seconds. It shall be noted, though, that in other embodiments, longer or shorter request times may be chosen, for example a request time of 5 to 10 seconds or 20 to 30 seconds, or a request time above 30 seconds or below 5 seconds. In general, the request time dependents on the processing speed of the control unit and/or the control centre and on the number of sensors whose readings have to be taken into consideration. Additionally, a certain security buffer is taken into account such as not to miss any sensor reading. In general, it may be desirable that the request time is kept relatively low, if at all possible below 15 seconds.

At step 102, a response is provided to the request. This response may encompass either the indication that the pump operation may be started or the indication that the pump operation should not be started, depending on the pre-start conditions 1000 having been met or not. This information may be obtained, by the control unit, on the basis of the evaluation of certain parameter values from a plurality of sensors as further explained in relation to FIG. 2.

If the response encompasses a positive feedback on starting the pump operation, designated by “Y” in the flow chart of FIG. 1A, the flow chart proceeds along the way indicated by steps 200, 201 and so forth. If the response encompasses a negative feedback on starting the pump operation, designated by “N” in the flow chart of FIG. 1A, the method proceeds along the way indicated by steps 401 and 500.

For ease of reference, the further steps in case of a negative feedback will now be described. That is, if it is indicated in step 102 that the pump operation shall not be started to begin with, which may be a result of one or more pre-start conditions 1000 not being met, the initiating of the pump operation is terminated in step 500. That is, in this case, the pump is prevented from being started altogether. If this is the case, in the exemplary embodiment of FIG. 1A, the method further encompasses, in step 401, sending a respective indication to e.g. the control unit or a control centre or another external entity, such as e.g.

a service device for forwarding the indication to a portable monitor at a service person responsible for servicing the water extinguishing system in order to inform said person that the pump operation and, hence, the pump test run, has not taken place. This indication will, in the following, be referred to as a pump test run termination indication. That is, in step 401, a pump test run termination indication is signalled so as to inform the responsible personnel of the termination, respectively the non-initiation, of the pump test run.

On the other hand, in case of a positive feedback, the method will proceed to step 201 in which a test signalling is activated in order to initiate the pump test run. Further, step 200 is executed in which a pump test run indication is sent. This pump test run indication may preferably be sent to the same entities that should receive the pump test run termination indication in the alternative. That is, the pump test run indication may particularly be sent to the control unit, a control centre or another external entity, such as e.g. a service device for forwarding the indication to a portable monitor at a service person responsible for servicing the water extinguishing system. This informs the responsible persons about the initiation of the pump test run, i.e. informs them that the pump test run is now started due to the pre-start conditions 1000 having been met.

As discussed, in step 201, the test signalling is activated in order to initiate the pump test run. Again, this signalling may be continued for a certain time span. In the specific embodiment according to FIG. 1A this time frame corresponds to 60 seconds. However, it shall be noted that this time frame may also be different, in particular longer or shorter than 60 seconds. In some cases, the time frame may be 10 seconds, 20 seconds, 30 seconds, 40 seconds or 50 seconds or below 10 seconds. In some embodiments, the time frame may be 70 seconds, 80 seconds, 90 seconds or above 90 seconds if desirable. Even longer or shorter time frames are envisioned.

In step 202, the test signalling leads to the activation of the controlling of a magnetic valve in the distribution line in order to initiate the pump test run. In particular, the test running signal causes the control unit to activate the controlling of the magnetic valve to open and close in order to allow the fluid to pass through the valve in the open state and to prohibit the fluid from passing through the valve in the closed state.

Upon activation of the controlling of the magnetic valve, the method proceeds to step 203 in which it is determined whether the first of the two redundant pressure switches for starting the pump has been activated. This activation is typically initiated by the control unit providing a control signal which opens a small discharge valve close to the first pressure switch which is in connection with an activation switch of the pump. The opening of the discharge valve leads to a local drop in pressure which leads to a switching of the first pressure switch which, in turn, leads to a switching of the activation switch and, hence, an activation of the pump. Through this arrangement, it can firstly be tested whether the pump is working properly and, secondly, whether the first of the two redundant pressure switches is working properly.

Hereby, a certain time frame may be chosen in which the pressure switch shall be activated, i.e. shall switch. As an example, this time frame may be 60 seconds. However, this time frame may also be longer, such das 90 seconds, 100 seconds 110 seconds, 120 seconds or anything in between 60 seconds and 120 seconds. The selection of this time frame may depend on the system and the system owner's preferences. If the pressure switch has not activated, typically after a given pre-set time,—indicated by the “N”-path in FIG. 1A—this is considered as an indication that there is not sufficient pressure loss in the distribution line at the pressure switch or that the pressure switch is not properly functioning and, hence, the pump test run may not be properly performed. As such, the determination of the activation of a pressure switch is regarded, in the exemplary embodiment of FIG. 1A, as one possible post-start condition 2000 for the pump test run. Thus, if the pressure switch is not activated in step 203, this may lead to the conclusion that a post-start condition 2000 is not met. Hence, the method proceeds to step 400, at which the pump test run is aborted and, then, to step 401 at which the pump test run termination indication is sent as described herein above.

On the other hand, if it is determined, in step 203, that the pressure switch has been activated-indicated by the “Y”-path in FIG. 1A—the method proceeds, on the one hand, to step 300. Step 300 encompasses the sending of a pressure switch activation indication, i.e. the signalling that the pressure switch has been active. Again, this signalling may be performed to one or more of the control unit, a control centre, a service device for forwarding the information to one or more end user devices used by service personnel or the like. The pressure switch activation indication indicates that the pressure switch has activated.

Further, if it is determined in step 203 that the pressure switch has been activated, the post-start condition 2000 is deemed met. In the specific embodiment of FIG. 1A, not only the activation of the pressure switch is regarded, but also the response time of the pressure switch, i.e. the time elapsed until the pressure switch has been activated. If the time elapsed is below a certain threshold value, such as 60 seconds in the specific embodiment of FIG. 1A, the response time is deemed appropriate and, hence, a further post-start condition 2000 is deemed met. In case both post-start conditions 2000 regarded are considered met, the method proceeds to step 204 as shown in FIG. 1B.

In step 204, the controlling of the magnetic valve is deactivated since the pump test run will proceed. Upon deactivation of the magnetic valve, the pump test run is executed for a certain time. In the specific embodiment of FIG. 1B, this time amounts to 15 minutes. However, it is noted that the invention is not limited to this amount of time. The pump test run time may also be below 15 minutes, for example 5 minutes, 10 minutes, or anything between 1 second to 15 minutes or even above 15 minutes, such as 20 minutes, 25 minutes or any other value above 15 minutes. Hereby, the time should be chosen in dependence on the pump properties and selected such as to ensure a proper pump test run.

Once the pump test run time has elapsed, a pump deactivation signal may be sent in step 205. This signal may preferably be provided by the control unit which is configured to control the pump test run. This pump deactivation signal will cause the pump to shut down.

This shut down may encompass a certain calming down period of the pump. In the specific embodiment of FIG. 1B, this calming down period amounts to 30 seconds. However, it shall be noted that the calming down period may also be shorter than 30 seconds, e.g. anything between 1 second and 30 seconds or longer than 30 seconds. The calming down period may specifically be selected to allow a proper calming of the pump after the pump test run.

After the calming down period has elapsed, the method may proceed to step 206 in which the controlling of the magnetic valve is activated again. If this activation is properly detected, the pump test run may continue by, essentially, repeating steps 203 to 206 in order to perform another pump test run initiated by switching the second one of the redundant activation switches of the pump. In particular, the proper activation of the magnetic valve may be regarded as a further post-start condition 2000 in view of which the pump test run may continue.

The method may then proceed to step 207 in which it is determined whether or not the second of the two redundant pressure switches for starting the pump has been activated. Also here, the activation is typically initiated by the control unit providing a control signal which opens a small discharge valve close to the second pressure switch which is in connection with the activation switch of the pump. Again, the opening of the discharge valve leads to a local drop in pressure which leads to a switching of the second pressure switch which, in turn, leads to a switching of the activation switch which activates the pump. By means of this arrangement, the second pressure switch may be tested. Since the pump as such has already been tested when the first pressure switch was tested, in this case the pump test run may be shorter than the one previously performed. However, it is also conceivable that the pump test run lasts for the same time or is even longer than the first pump test run.

If the second pressure switch has activated, the response time of the pressure switch is also determined. If the pressure switch has not activated-indicated by the “N”-path in FIG. 1B, the post-start condition 2000 is deemed not met and the method proceeds once more to step 400 (shown in dashed lines in FIG. 1B) in which the pump test run is terminated and step 401 (likewise shown in dashed lines in FIG. 1B) in which a pump test run termination indication is provided as discussed herein above.

On the other hand, if the second pressure switch has been activated-indicated by the “Y”-path in FIG. 1B, the post-start condition 2000 is again deemed met and the method proceeds to step 208 in which the controlling of the magnetic valve is, again, deactivated. The pump test run is then continued for a certain time which, in the specific embodiment of FIG. 1B corresponds to 5 minutes, i.e. shorter than the first pump test run for the reasons as explained above. It is noted that the pump test run time may also be longer than 5 minutes, e.g. 10 minutes or 15 minutes or even above or anything between or shorter than the 5 minutes, e.g. 1 minute or below or anything between 1 minute and 5 minutes. The time frame for running the pump test run may particularly depend on the pump that is tested and/or other factors such as the pump age, the overall state of the water extinguishing system and the like.

After the pre-set time for performing the pump test run has been elapsed, the method proceeds to step 209 in which a pump deactivation signal is again provided to deactivate the pump. In response to the deactivation signal, the pump is shut down. This shut down requires a certain calming down period which, in the specific embodiment of FIG. 1B, corresponds to 30 seconds. As discussed herein above, the calming down period may, however, also be longer or shorter than 30 seconds, e.g. anything between 1 second and 30 seconds or above 30 seconds. The calming down period may be selected to allow a proper calming of the pump after the pump test run.

The method then proceeds to step 210 in which a signal is provided by the control unit to finish the pump test run. In that regard, the method further encompasses, at step 600, sending a pump test run finishing indication to one or more of the control unit, a control centre, a service device configured to forward said indication to one or more end user devices belonging to service personnel or the like. Further, the method proceeds to step 500 in which the pump start operation is terminated, i.e. to finalize the pump test run.

It is noted that, in the above embodiments, the post-start conditions 2000 regarded are mainly based on the activation and response time of the pressure switch. In that regard, further post-start conditions 2000, albeit not explicitly mentioned in relation to FIG. 1B may also be regarded.

As an example, the post-start condition may be determined using a (direct) measurement of the pressure of the extinguishing fluid at or within the fluid supply line, in particular at the pump inlet. This may allow determining whether the extinguishing fluid is entering the pump with a pressure sufficient to provide for an effective fire protection in case the water extinguishing system is activated and may be used as a condition on whether or not to continue the pump test run.

A pressure sensor may, alternatively or additionally, be provided to determine a pressure of the extinguishing fluid at or in a pressurized fluid storage tank, such as a fluid reservoir the pressurized fluid storage tank being in fluid connection with supply line, the pump and the distribution line. Since the pressure of the extinguishing fluid is an important measure to determine whether a pump test run may safely be executed, this monitoring is particularly desirable in order to determine whether or not to continue or abort the pump test run.

A further parameter considered when determining the post-start condition is the temperature of the extinguishing fluid at the pump inlet which may indicate the temperature at or within the pump and may be used to determine whether the pump could be sufficiently cooled during the pump test run. If this is not the case, the post-start condition may indicate that the pump test run should be aborted to prevent the pump from overheating.

An additional parameter may also be the temperature of a rotary shaft of the pump or, more particularly, of the extinguishing fluid as leaking from a sealing member enveloping the rotary shaft. As discussed, the temperature of and at the pump is an important indicator on whether or not a pump test run should be continued.

Further parameter values to be evaluated with respect to potential post start conditions may comprise the pressure of the extinguishing fluid at or within the fluid distribution line and the fluid supply line, preferably at the pump outlet. The post-start condition may further encompass the pressure of the extinguishing fluid at or within the distribution line, in particular at the pump outlet or at the valve inlet.

Another possibility of determining the post-start condition may be to monitor the flow rate of the extinguishing system in both the fluid supply line and the fluid distribution line. Based on a measurement of the flow rate, it may be determined whether there is any leakage in the system and, even if there is not, if there is any damaged part of the system that is in need of repair. Based on this assessment, it may be decided as to whether or not the pump test run should be continued.

Another option would be the sensor reading of a vibration sensor which may sense the vibration of the pump, preferably of the pump housing, and/or the vibration of a pipe forming a part of the distribution line. Here, the test run may be considered to be aborted in response to a post-start condition not being met, if the vibration changes or exceeds a critical vibration threshold, thereby leading to the conclusion that there has been some disruption and/or irregularity in the pump or the pipe system.

Further, a leakage sensor for measuring leakage, preferably in the form of fluid drop rate, from the fluid supply line and/or the fluid distribution line may be envisioned. Based on the fluid drop rate, the amount of leakage may be determined which may allow to conclude that there is too little extinguishing fluid provided to the pump during the pump test run in order to properly cool the pump. In such a case, the post-start condition may be deemed not met and the pump test run may be aborted.

A leakage sensor may also be used for determining leakage, preferably in the form of fluid drop rate, at the sealing member at the rotary shaft of the pump. As such, a sensor may be provided to monitor the sealing member thereby allowing to conclude whether the sealing member enveloping the rotary shaft is in a condition in which the pump test run may be safely executed.

There may also be a current sensor provided to monitor an operating electrical current and/or an operating electrical current status of the pump in the case where the pump is an electrically operated pump. The determination of the operating electrical current and/or the operating electrical current status may allow to draw conclusions regarding the pump's functionality and may thus allow to determine, as a post-start condition, whether the pump test run should be continued or aborted.

The sensors may further encompass a pressure sensor and/or a flow rate sensor and/or a combined sensor for measuring pressure and flow rate at or within the bypass line branching off from the distribution line and being configured to conduct the extinguishing fluid away from the fluid distribution line towards a drain outlet and/or the supply pipe system. In particular, if the pressure and/or flow rate are determined to be too low to safely execute the pump test run, it may be aborted in response to a post-start condition not being met.

There are further measurements and sensor readings imaginable, which may be used to decide upon whether or not the pump test run shall be started (and may, thus, serve as pre-start conditions) or continued (and may, therefore, serve as post-start conditions).

FIG. 2 shows a schematic representation of a water extinguishing system 1 according to an embodiment of the invention. The water extinguishing system 1 comprises a pump 10, a fluid supply line 20, a fluid distribution line 30, a test line 40, a control unit 50, a pipe system 60 including fluid outlets 61 and a fluid reservoir 70 for storing the extinguishing fluid.

The fluid distribution line 30 comprises a valve 31 and pressure switches 32a and 32b situated between the valve 31 and the pump 10. Pressure switches 32a and 32b are implemented redundantly and used for starting the pump test run as described herein above. For this purpose, a small discharge valve is provided close to pressure switches 32a and 32b which is not illustrated in FIG. 2.

The valve 31 may particularly be an alarm valve having an opening state and a closing state that is dependent on the alarm state of the water extinguishing system 1. Specifically, in the exemplary embodiment of FIG. 2, the water extinguishing system corresponds to a wet alarm system. In such systems, if a fire event occurs in an area monitored by the water extinguishing system 1, the fluid outlets 61 open, leading to a drop in the pressure within the pipe system 60 which leads to the valve 31 being opened in order to allow the distinguishing fluid to flow from the fluid distribution line 30 towards the fluid outlets 61. This typically also leads to fluid flowing into the alarm section of the alarm valve 31 causing the alarm state to be initiated. Further, the pressure drop also leads to a drop in pressure which causes pressure switch 32 to activate the pump 10 via activation switches 11a and 11b.

While in the exemplary embodiment of FIG. 2, the water extinguishing system corresponds to a wet alarm system, in which the alarm valve 31 is a wet alarm valve, it is conceivable that the same principle also allows for dry alarm systems having a valve 31 implemented as a dry alarm valve.

Further, in other embodiments, in which the water extinguishing system corresponds to a pre-action dry system or a deluge system, it is the control unit and/or a control centre which is in signal connection with respective fire detection devices and receives an indication about a fire event from one or more of those devices that opens the valve 31 which causes the pump to be started as described herein above.

The test line 40 is provided with an opening element 41, such as a magnetic valve, which may be changed from an open state in which the test circuit comprising the fluid supply line 20, the fluid distribution line 30 and the test line 40 is opened to a closest state in which the test circuit is closed. Branching from the test line 40 is bypass line 42. Bypass line 42 has a smaller cross section compared to the test line 40 and, hence, is capable of conducting only a portion of the extinguishing fluid that might be conducted through the test line if the opening element 41 is opened. In the specific embodiment of FIG. 2, the bypass line 42 has a cross section that amounts to roughly 2% of the cross section of the test line 40, meaning that the bypass line 42 may also conduct only 2% of the extinguishing fluid that might be conducted by the test line 40. It is noted that, although the test line 40 branches from the distribution line 30 and into the supply line 20 in the embodiment of FIG. 2, in other embodiments, the test line 40 may branch from a different line or even from the pump in the water extinguishing system 1. The important part about the test line 40 is that it is fluidly connected to the pump and may be used to conduct extinguishing fluid during a pump test run. Similarly, although the test line 40 is illustrated as branching into the fluid supply line 20, it may also branch into the fluid reservoir 70 and/or another fluid connection line leading to the pump 10. That is, the test line 40 is not limited to branching from the fluid supply line 20 and/or the fluid distribution line 30.

Further, although the bypass line 42 is illustrated as branching from the test line 40, it is also conceivable that the bypass line 42 branches directly from the fluid distribution line 30 or the pump 10. Similarly, although the bypass line 42 is illustrated as branching into the test line 40, it may also branch into the fluid supply line 20, the fluid reservoir 70, another fluid connection line leading to the pump 10 and/or any discharge outlet. That is, the bypass line 42 is likewise not limited to a particular branching scheme, as long as it fulfils its purpose of bypassing the fluid around the opening element of test line 40.

The pump 10 is in signal connection with control unit 50 Further, the pump 10 is provided with a switch 11, which is in direct connection with pressure switches 32a and 32b. As described herein above, in order to initiate pump operation, a small discharge valve adjacent to pressure switches 32a and 32b is opened, causing a small drop in pressure close to the pressure switches 32a and 32b. This may cause the pressure switches 32a and 32b to switch. Now, both pressure switches are in direct connection with the activation switch 11 at the pump 10, whereby, in the exemplary embodiment of FIG. 2, pressure switch 32a is switching activation switch 11 to activate the pump.

This may cause a pump test run to be started. In the specific embodiment of FIG. 2, the pump 10 is configured to perform the pump test run through the bypass line 42. Accordingly, in the specific embodiment of FIG. 2 it is not required that the opening element in test line 40 is opened. Instead, the pump test run of the pump 10 is performed using the fluid of the bypass line 42. As discussed herein above, this means that it should be ensured that there are no deposits and/or cavitation in bypass line 42 such as to ensure a proper amount of fluid being conducted therein which allows to properly cool the pump 10. For this purpose, the bypass line 42 is provided, in the specific embodiment of FIG. 2, with a sensor 25 whose functioning will be described further below.

In the exemplary embodiment of FIG. 2, the control unit 50 may control the pump operation, in particular the pump test run, by e.g. executing the method according to FIGS. 1A and 1B as described herein above.

The water extinguishing system 1 further comprises a plurality of sensors 21, 22, 23, 24, 25, 26 and 27. It is noted that any of the sensors 21, 22, 23, 24, 25, 26 and 27 may be implemented as any sensor as described herein above, such as a pressure sensor, a temperature sensor, a vibration sensor, a flow sensor, a leakage sensor, a current sensor and/or a sensor for detecting the activation state and/or the response time of a pressure switch and/or any other sensor previously described. In the specific embodiment of FIG. 2, each of the sensors is in signal communication with the control unit 50.

In the specific embodiment according to FIG. 2, the sensor 21 is implemented as a vibration sensor. The sensor 22 is implemented as a temperature sensor and the sensor 23 is implemented as a leakage sensor. Further, the sensor 24 is implemented as a sensor for sensing the activation state of a pressure switch 32. The sensor 25 is implemented as a flow sensor sensing the flow rate through the bypass line 42, and the sensor 26 is implemented as a pressure sensor for determining the pressure behind the valve 31, i.e. between the valve 31 and the pipe system 60 in which the fluid outlets 61 are arranged.

In the specific embodiment of FIG. 2, sensor 21 is used to monitor a vibration of the pump 10, in particular at the pump housing of the pump 10. Hereby, the vibration monitoring may be used to derive a pump operation condition, in particular a post-start condition.

Specifically, if the vibration monitored changes, this may be indicative of a disruption and/or irregularity with the pump operation and/or the fluid supply line 20, the fluid distribution line 30 and/or the bypass line 42, such as cavitation in any of these lines which may lead to insufficient fluid conduction and, as a result, to overheating of the pump 10. As such, the change in vibration may cause an evaluation by the control unit 50 which renders the result that the post-start condition is not met anymore and the pump test run should be aborted.

It is noted that, in principle, a cavitation may also mean that the pump test run should not be started at all, i.e. might also be indicative for a pre-start condition not being met. However, the vibration of the pump 10 may only be obtained once the pump has been started. As such, the sensor reading provided by the vibration sensor 21 may only serve to determine a post-start condition.

Further, in the embodiment of FIG. 2, the sensor 22 is used to monitor the temperature of the extinguishing fluid at the pump outlet of the pump 10 towards the distribution line. This monitoring of the temperature of the extinguishing fluid at the pump outlet may likewise be used to determine whether or not a post-start condition is fulfilled. In particular, the control unit 50 may receive sensor readings from sensor 22 that show a continuous increase in extinguishing temperature at the pump outlet. This may be considered as an indication that the pump 10 is heating up, potentially due to insufficient cooling. In order to avoid damage to the pump 10, the control unit may consider a post-start condition to not be fulfilled and abort the pump test run. In some embodiments, the control unit 50 may hereby be configured to compare the temperature measured by sensor 22 to a pre-set threshold value and may abort the pump test run only at that point where the threshold is reached. In other embodiments, the continuous increase without the necessity to reach a certain threshold may be used as the criterion for aborting the pump test run.

In the embodiment of FIG. 2, the sensor 23 is implemented as a leakage sensor situation in the fluid distribution line 30. In the specific embodiment of FIG. 2, sensor 23 particularly measures the fluid drop rate in the fluid distribution line 30 between pressure switches 32a and 32b and valve 31. Hereby, the control unit 50 may be configured to receive the sensor reading from sensor 23 and compare the fluid drop rate measured against a pre-set threshold value. If the fluid drop rate exceeds said threshold, i.e. is higher than a certain value, the control unit 50 may take this as an indication that too much extinguishing fluid is leaking from the system and the pump operation, in particular the pump test run, should be aborted due to a post-start condition not being met. The leakage measurement may also be used to be indicative of a pre-start condition. That is, the control unit 50 may be configured to prevent the pump operation, in particular the pump test run, from being initiated in case the fluid drop rate is above a certain threshold. As such, the fluid drop rate and, hence, the leakage measured by sensor 23 may be considered for both, pre-start and post-start conditions of the pump 10.

The sensor 24 is, in the embodiment according to FIG. 2, provided at pressure switches 32a and 32b and may monitor the activation of these pressure switches 32a and 32b in response to pressure changes. The sensor 24 is further configured to determine the response time of the pressure switches 32a and 32b. The sensor 24 provides a reading about whether or not the pressure switches 32a and 32b have activated and, if it has activated, at which reaction time it has activated, to control unit 50. The control unit 50 may use this sensor reading to determine whether the pump operation, in particular the pump test run, shall be continued or not as described in relation to FIGS. 1A and 1B.

The sensor 25 is implemented, in the specific embodiment according to FIG. 2, as a flow sensor for sensing the flow rate through the bypass line 42 and may thus be indicative of whether or not sufficient fluid is provided through the bypass line 42 in order to cool the pump 10 during the pump test run. In particular, the sensor 25 may be implemented to monitor whether the flow rate through the bypass line 42 remains constant or changes, in particular decreases, e.g. due to deposits inside the test line blocking a part thereof or due to leakage leading to a reduction of the flow rate. In particular, the control unit 50 may be configured to obtain the sensor reading from flow sensor 25 and may compare the flow rate measured to a pre-set threshold value. If the flow rate drops below such threshold, this may be taken as an indication that the flow rate is not sufficient anymore to properly cool the pump. As such, the flow rate measured may be used to determine a post-start condition according to which the pump test run is continued as long as the flow rate is maintained above said threshold value and according to which the pump test run is aborted if the flow rate drops below said threshold value.

Further, the sensor 26 is implemented, in the specific embodiment according to FIG. 2, as a pressure sensor for measuring the pressure of the fluid at the valve outlet of valve 31. Hereby, the term fluid may refer to the extinguishing fluid in case of a wet alarm valve or, alternatively, to a gas or air in case of a dry alarm valve. Hereby, the pressure should ideally be constant. If, however, a sudden drop in pressure is determined by the control unit 50, in particular a drop below a certain threshold value, this may be indicative of an activation state of the water extinguishing system. In such a case, the pump test run should not be started if it has not been initiated or should be aborted if it has been initiated previously. As such, the pressure measurement at this position may be used to determine both a pre-start and a post-start condition.

Finally, the sensor 27 is implemented, in the specific embodiment according to FIG. 2, as a pressure sensor for measuring the pressure of the fluid inside the pipe system 60 including the fluid outlets 61. The fluid inside the pipe system 60 may hereby likewise either correspond to air or gas for a dry system including a dry alarm valve 31 or to a liquid for a wet system including a wet alarm valve 31. In particular, the pressure sensor 27 should be able to monitor a constant pressure inside the pipe system 60. If the pressure gradually decreases over time with a rate exceeding a certain threshold rate, this may be considered as an indication that leakage is present within the pipe system 60. If, however, a drop in pressure below a certain threshold value is detected by the control unit, this may be considered as an indication that the water extinguishing system 1 is in an alarm state. This may be counter-indicative to starting and/or continuing the pump test run. As such, the pressure measurement by the sensor 27 may be used by the control unit to determine a pre-start and/or a post-start condition being met.

It is noted that, in the above embodiment according to FIG. 2, the position and selection of sensors is only exemplary. The sensors used may be different sensors and, accordingly, their respective position in the system may be different. In that regard, the skilled person will appreciate, from the above general description the variety of sensors that may be used and their respective positioning necessary for this purpose. As an example, the skilled person may appreciate that, in order to determine the pressure of the fluid in the fluid reservoir 70, a respective pressure sensor should be provided at or within the fluid reservoir 70.

### LIST OF REFERENCE NUMBERS

1 water extinguishing system
10 pump
11 activation switch
20 fluid supply line
21, 22, 23, 24, 25, 26, 27 sensors
30 fluid distribution line
31 valve element
32a, 32b pressure switch
40 test line
41 opening element
42 bypass line
50 control unit
60 pipe network
61 fluid outlets
70 fluid storage
100 Initiate pump operation
101 Request conditions from control unit
102 Provide response by control unit
200 Send pump test run start indication
201 Activate test signalling
202 Activate controlling of magnetic valve
203 Determine activation of pressure switch
204 Deactivate controlling of magnetic valve
205 Send pump deactivation signal
206 Activate controlling of magnetic valve
207 Determine activation of pressure switch
208 Deactivate controlling of magnetic valve
209 Send pump deactivation signal
210 Send pump test run termination signal
300 Signal pressure switch activation indication
301 Signal pressure switch activation indication
400 Terminate pump test run
401 Signal pump test run termination indication
500 Terminate pump starting operation
600 Signal pump test run finishing indication
1000 pre-start condition
2000 post-start condition

1. A water extinguishing system comprising:
a fluid supply line for providing an extinguishing fluid;
a fluid distribution line for distributing the extinguishing fluid to at least one extinguishing fluid outlet;
a pump comprising a housing, a pump inlet in fluid connection with the fluid supply line and a pump outlet in fluid connection with the fluid distribution line; and
a control unit;
wherein the water extinguishing system comprises a plurality of sensors in signal connection with the control unit, wherein each of the plurality of sensors is configured to obtain at least one parameter value of a parameter indicative of an operating state of the water extinguishing system,
wherein the control unit is configured to receive the at least one parameter value from at least one of the plurality of sensors; determine, based on an evaluation of the at least one parameter value, at least one pump operation condition; and control a pump operation comprising a pump test run based on the at least one pump operation condition,
wherein the at least one pump operation condition comprises one or more of: a pre-start condition, wherein the pre-start condition specifies a pump operation condition that is used by the control unit prior to initiating the pump operation to determine whether to initiate the pump test run, a post-start condition, wherein the post-start condition specifies a pump operation condition that is regarded by the control unit after the pump operation has been initiated to determine whether to continue the pump test run after the pump test run has been initiated; and
wherein the control of the pump operation further comprises one or more of:
allowing initiating the pump test run if the pre-start condition is met,
preventing initiating the pump test run if the pre-start condition is not met.

2. The water extinguishing system according to claim 1, wherein the plurality of sensors comprises at least one of a pressure sensor, a temperature sensor, a flow sensor and/or a vibration sensor.

3. The water extinguishing system according to claim 1, wherein the plurality of sensors comprises at least one pressure sensor configured to determine one or more of:
a pressure of the extinguishing fluid at or within the fluid supply line, a pressure of the extinguishing fluid at or within the fluid distribution line,
a pressure of the extinguishing fluid at or within a fluid storage, the fluid storage in fluid connection one or more of the fluid supply line and/or the fluid distribution line,
a pressure in a bypass line branching from the fluid distribution line to conduct the extinguishing fluid away from the fluid distribution line,
a pressure of an oil storage of the pump.

4. The water extinguishing system according to claim 1, wherein the plurality of sensors comprises at least one temperature sensor configured to determine one or more of:
a temperature of the extinguishing fluid at the pump inlet,
a temperature of the extinguishing fluid at the pump outlet,
a temperature at the housing of the pump,
a temperature of a room in which the pump is provided,
a temperature of a rotary shaft of the pump,
a temperature of an oil storage of the pump,
a temperature of a cooling liquid of the pump.

5. The water extinguishing system according to claim 1, wherein the plurality of sensors comprises at least one flow sensor configured to determine one or more of:
a flow rate of the extinguishing fluid in the fluid supply line,
a flow rate of the extinguishing fluid in the fluid distribution line,
a flow rate within a bypass line branching from the fluid distribution line to conduct the extinguishing fluid away from the fluid distribution line,
a flow rate of a cooling liquid of the pump.

6. The water extinguishing system according to claim 1, wherein the plurality of sensors comprises at least one vibration sensor configured to determine one or more of:
a vibration of the pump,
a vibration of a pipe along the fluid distribution line.

7. The water extinguishing system according to claim 1, wherein the plurality of sensors comprises at least one first sensor configured to determine one or more of:
an activation state of a pressure switch at or within the fluid distribution line,
a response time of a pressure switch at or within the fluid distribution line,
an operating current of the pump, wherein the pump comprises an electrical pump,
an operating current state of the pump, wherein the pump comprises an electrical pump,
a determination of a fuel level of the pump, wherein the pump comprises a diesel pump,
a determination of an oil level in an oil storage of the pump,
a determination of a cooling liquid level of the pump,
a motor speed of the pump, wherein the pump comprises a diesel pump,
leakage from the fluid supply line,
leakage from the fluid distribution line.

8. The water extinguishing system according to claim 1, wherein the control unit is configured to provide, in response to the pre-start condition being met, a trigger signal causing a switching element of the pump to change an activation state to an active state.

9. The water extinguishing system according to claim 8, wherein the pre-start test condition comprises an indication of a time elapsed between providing the trigger signal and the change of the activation state.

10. The water extinguishing system according to claim 1, wherein the at least one pump operation condition comprises the post-start condition, and
wherein the control unit is configured to control the pump test run based on the post-start condition, wherein the control the pump run test comprises:
allowing the pump test run to continue if the post-start condition is met;
aborting the pump test run if the post-start condition is not met.

11. A method for controlling a pump operation comprising a pump test run in a water extinguishing system, said water extinguishing system comprising a fluid supply line in fluid connection with a fluid distribution line for distributing an extinguishing fluid to at least one extinguishing fluid outlet, a pump comprising a housing, a pump inlet in fluid connection with the fluid supply line and a pump outlet in fluid connection with the fluid distribution line, a control unit, and a plurality of sensors in signal connection with the control unit, the method comprising:
obtaining, by at least one of the plurality of sensors, at least one parameter value of a parameter indicative of an operating state of the water extinguishing system;
receiving, at the control unit, the at least one parameter value from at least one of the plurality of sensors;
evaluating, at the control unit, the at least one parameter value;
determining, at the control unit, based on the evaluating, at least one pump operation condition; and
controlling, by the control unit, the pump operation comprising the pump test run based on the at least one pump operation condition, wherein the at least one pump operation condition comprises one or more of:
a pre-start condition, wherein the pre-start condition specifies a pump operation condition that is used by the control unit prior to initiating the pump operation to determine whether to initiate the pump test run,
a post-start condition, wherein the post-start condition specifies a pump operation condition that is regarded by the control unit after the pump operation has been initiated to determine whether to continue the pump test run after the pump test run has been initiated; and wherein the controlling comprises one or more of:
allowing initiating the pump test run if the pre-start condition is met,
preventing initiating the pump test run if the pre-start condition is not met.

12. The method of claim 11, wherein the method further comprises
providing, by the control unit, a trigger signal in response to the pre-start condition being met;
changing an activation state of a switching element of the pump to an active state based on the trigger signal.

13. The method of claim 11, wherein the at least one pump operation comprises the post-start condition, the method further comprising:
controlling, by the control unit, the pump test run based on the post-start condition, wherein the controlling comprises:
allowing the pump test run to continue if the post-start condition is met; and
aborting the pump test run if the post-start condition is not met.
